(19) United States
(12) Patent Application Publication
(10) Pub. No.: US 2015/0062498 A1
(43) Pub. Date: Mar. 5, 2015

(54) LIQUID CRYSTAL LENS AND LIQUID CRYSTAL DISPLAY APPARATUS HAVING THE SAME

(71) Applicant: SAMSUNG DISPLAY CO., LTD., YONGIN-CITY (KR)

(72) Inventor: SHUAI JIANG, YONGIN-SI (KR)

(73) Assignee: SAMSUNG DISPLAY CO., LTD., YONGIN-CITY (KR)

(21) Appl. No.: 14/248,034

(22) Filed: Apr. 8, 2014

(30) Foreign Application Priority Data
Sep. 3, 2013 (KR) 10-2013-0105256

(51) Int. Cl. G02F 1/1337

(52) U.S. Cl. CPC G02F 1/1337; G02F 1/133723
USPC 349/96; 349/123

(57) ABSTRACT

A liquid crystal lens is disclosed. The liquid crystal lens includes a first substrate, a second substrate, a liquid crystal layer, and an alignment layer. The first substrate includes a plurality of electrodes. The second substrate faces the first substrate. The liquid crystal layer is disposed between the first substrate and the second substrate. The liquid crystal layer includes liquid crystal molecules and a mesogen. The alignment layer is disposed between the liquid crystal layer and the first substrate or between the liquid crystal layer and the second substrate. The mesogen includes an acrylate functional group. The acrylate functional group contacts the liquid crystal layer, preventing a flow of the liquid crystal molecules.

### CROSS-REFERENCE TO RELATED APPLICATIONS

This application claims priority under 35 U.S.C. §119 to Korean Patent Application No. 10-2013-0105256, filed on Sep. 3, 2013 in the Korean Intellectual Property Office (KIPO), the disclosure of which is incorporated by reference herein in its entirety.

### TECHNICAL FIELD

Exemplary embodiments of the present invention relate to liquid crystal display, and more specifically, to a liquid crystal lens and a liquid crystal display apparatus having the same.

### DISCUSSION OF THE RELATED ART

A liquid crystal lens uses a specific arrangement of liquid crystal molecules to function like an optical lens. The liquid crystal molecules may be rotated in an undesired direction by an electric field between fine patterns formed in the liquid crystal lens, and therefore, the response speed of the liquid crystal molecules may be reduced.

### SUMMARY

In accordance with an exemplary embodiment of the present invention, a liquid crystal lens includes a first substrate, a second substrate, a liquid crystal layer, and an alignment layer.

The first substrate includes a plurality of electrodes. The second substrate faces the first substrate. The liquid crystal layer is disposed between the first substrate and the second substrate. The liquid crystal layer includes liquid crystal molecules and a mesogen. The alignment layer is disposed between the liquid crystal layer and the first substrate or between the liquid crystal layer and the second substrate. The mesogen includes an acrylate functional group. The acrylate functional group contacts the liquid crystal layer and prevents a flow of the liquid crystal molecules.

In an exemplary embodiment of the present invention, the alignment layer may include a first alignment layer disposed between the liquid crystal layer and the first substrate, and a second alignment layer disposed between the liquid crystal layer and the second substrate.

In an exemplary embodiment of the present invention, the alignment layer may include polyimide.

In an exemplary embodiment of the present invention, the liquid crystal lens may further include an insulation layer disposed on the plurality of electrodes.

In an exemplary embodiment of the present invention, different voltages from each other may be applied to the electrodes, respectively.

In an exemplary embodiment of the present invention, the voltages may be in a range from about 0V to about 10V.

In an exemplary embodiment of the present invention, the plurality of electrodes each may have a stripe shape.

In an exemplary embodiment of the present invention, a pre-tilted angle of the liquid crystal molecules adjacent to the mesogen may be equal to or less than 10°.

In an exemplary embodiment of the present invention, the liquid crystal lens may further include a first polarizing plate and a second polarizing plate. The first polarizing plate may be disposed on a lower surface of the first substrate. The second polarizing plate may be disposed on an upper surface of the second substrate.

In an exemplary embodiment of the present invention, the liquid crystal lens may further include a sealant. The sealant may be disposed on each of two opposite ends of the first substrate and the second substrate. The sealant may seal the liquid crystal layer.

In accordance with an exemplary embodiment of the present invention, a liquid crystal display apparatus includes a liquid crystal lens and a display panel.

The liquid crystal lens includes a first substrate, a second substrate, a liquid crystal layer, and an alignment layer. The first substrate includes a plurality of electrodes. The second substrate faces the first substrate. The liquid crystal layer is disposed between the first substrate and the second substrate. The liquid crystal layer includes liquid crystal molecules and a mesogen. The alignment layer is disposed between the liquid crystal layer and the first substrate or between the liquid crystal layer and the second substrate. The mesogen includes an acrylate functional group. The acrylate functional group contacts the liquid crystal layer and prevents a flow of the liquid crystal molecules.

The display panel is disposed on a lower surface of the liquid crystal lens

In an exemplary embodiment of the present invention, the alignment layer may include a first alignment layer disposed between the liquid crystal layer and the first substrate and a second alignment layer disposed between the liquid crystal layer and the second substrate.

In an exemplary embodiment of the present invention, the alignment layer may include polyimide.

In an exemplary embodiment of the present invention, the liquid crystal lens may further include an insulation layer disposed on the electrodes.

In an exemplary embodiment of the present invention, different voltages from each other may be applied to the plurality of electrodes, respectively.

In an exemplary embodiment of the present invention, the voltages may be in a range from about 0V to about 10V.

In an exemplary embodiment of the present invention, the plurality of electrodes each may have a stripe shape.

In an exemplary embodiment of the present invention, a pre-tilted angle of the liquid crystal molecules adjacent to the mesogen may be equal to or less than 10°.

In an exemplary embodiment of the present invention, the liquid crystal lens may further include a first polarizing plate and a second polarizing plate. The first polarizing plate may be disposed on a lower surface of the first substrate. The second polarizing plate may be disposed on an upper surface of the second substrate.

In an exemplary embodiment of the present invention, the liquid crystal lens may further include a sealant. The sealant may be disposed on both ends of the first substrate and the second substrate. The sealant may seal the liquid crystal layer. According to an exemplary embodiment of the present invention, the weight of the mesogen may be in a range from about 0.1% by weight to about 1.0% by weight, with respect to the total weight of the liquid crystal layer.

### BRIEF DESCRIPTION OF THE DRAWINGS

The present disclosure will become more apparent by describing in detailed exemplary embodiments thereof with reference to the accompanying drawings, in which:

FIG. 1 is a perspective view illustrating a liquid crystal display apparatus in accordance with an exemplary embodiment of the present invention;

FIG. 2 is a cross-sectional view illustrating a liquid crystal lens as illustrated in FIG. 1 in accordance with an exemplary embodiment of the present invention;

FIG. 3 is a cross-sectional view illustrating a liquid crystal lens as illustrated in FIG. 2, in which voltages are applied to electrodes, in accordance with an exemplary embodiment of the present invention;

FIG. 4 is a phase shift graph illustrating a phase of a liquid crystal lens as illustrated in FIG. 3 in accordance with an exemplary embodiment of the present invention; and

FIGS. 5A to 5F are cross-sectional views illustrating a method for manufacturing a liquid crystal lens in accordance with an exemplary embodiment of the present invention.

### DETAILED DESCRIPTION OF EMBODIMENTS

Hereinafter, exemplary embodiments of the present invention will be described in detail with reference to the accompanying drawings. The same reference numerals may be used to denote the same or substantially the same elements throughout the specification and the drawings. The inventive concept, however, may be modified in various different ways, and should not be construed as limited to the embodiments set forth herein. As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

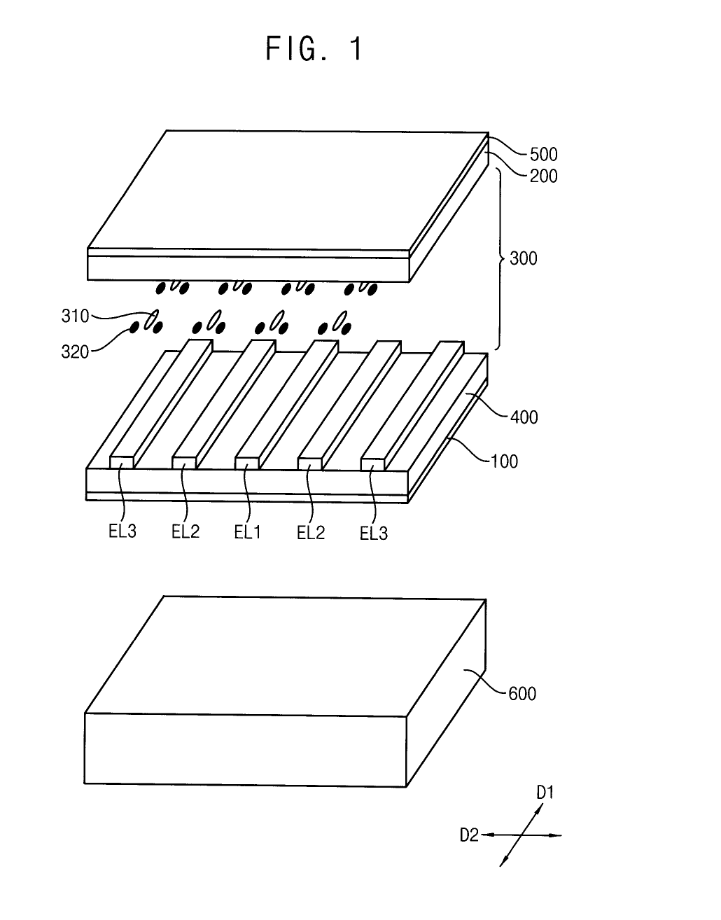

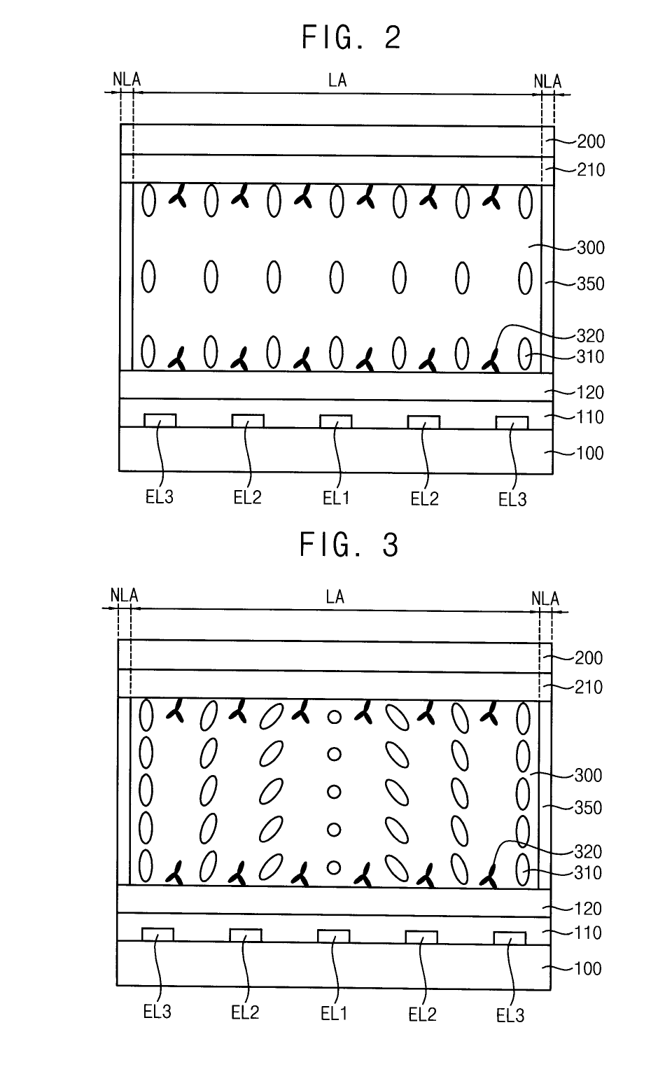

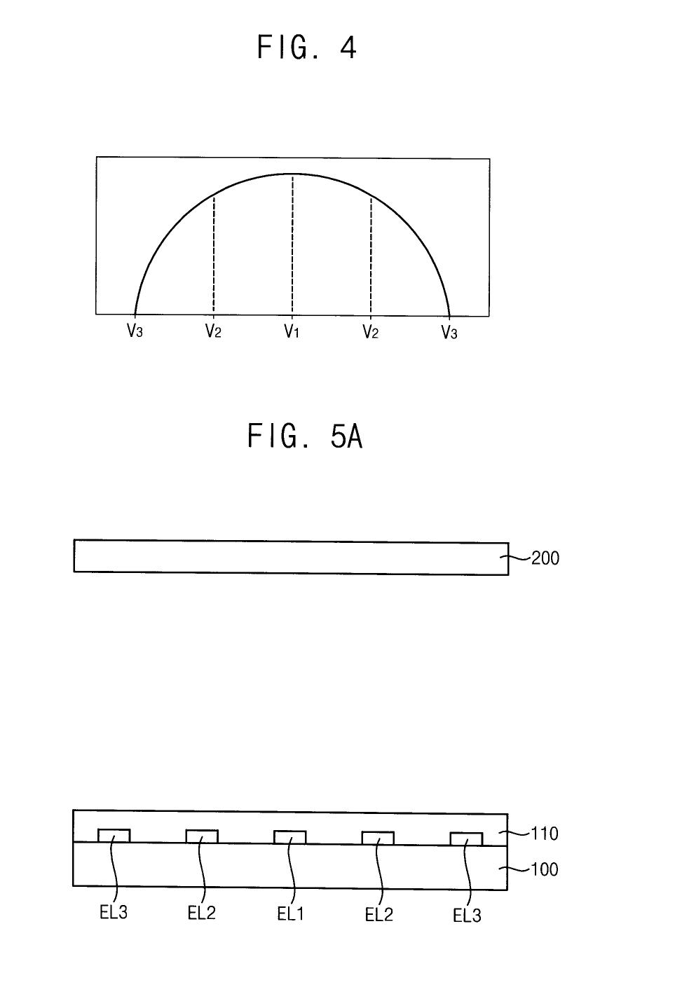

FIG. 1 is a perspective view illustrating a liquid crystal display apparatus in accordance with an exemplary embodiment of the present invention. FIG. 2 is a cross-sectional view illustrating a liquid crystal lens illustrated in FIG. 1, in accordance with an exemplary embodiment of the present invention. FIG. 3 is a cross-sectional view illustrating a liquid crystal lens illustrated in FIG. 2, where voltages applie to electrodes, in accordance with an exemplary embodiment of the present invention. FIG. 4 is a graph illustrating a phase shift of a liquid crystal lens as illustrated in FIG. 3, in accordance with an exemplary embodiment of the present invention.

A liquid crystal layer 300, as illustrated in FIG. 1, includes liquid crystal molecules 310 and mesogens 320 which are not hardened.

A liquid crystal layer 300, as illustrated in FIG. 2, includes liquid crystal molecules 310 and mesogens 320 which are hardened, with no electric field applied to the liquid crystal layer 300.

A liquid crystal layer 300, as illustrated in FIG. 3, includes liquid crystal molecules 310 and mesogens 320 which are hardened, with an electric field applied to the liquid crystal layer 300.

Referring to FIGS. 1 to 3, a liquid crystal display apparatus includes a liquid crystal lens and a display panel.

The liquid crystal display apparatus includes a first substrate 100, a second substrate 200, a liquid crystal layer 300 and a display panel 600.

The first substrate 100 includes a plurality of electrodes EL1, EL2, and EL3. The second substrate 200 faces the first substrate 100.

The first substrate 100 and the second substrate 200 may be plastic substrates, formed of, e.g., kapton, polyethersulphone (PES), polycarbonate (PC), polyimide (PI), polyethyleneterephthalate (PET), polyethylenenaphthalate (PEN), polyacrylate (PAR), fiber reinforced plastic (FRP), etc Alternatively, the first substrate 100 and the second substrate 200 may be glass substrates.

An insulation layer 110 may be disposed on the electrodes EL1, EL2, and EL3. The insulation layer 110 electrically insulates the electrodes EL1, EL2, EL3 from other elements.

The insulation layer 110 may be formed of an organic material or an inorganic material. Examples of the organic material and the inorganic material include a benzocyclobutene resin, an olefic resin, a polyimide resin, an acryl resin, a polyvinyl resin, a siloxane resin, a silicon resin, etc.

The display panel 600 may be a liquid crystal display (LCD) panel. Alternatively, the display panel 600 may be an electro luminescent display (ELD) panel, a field emission display (FED) panel, a surface-conduction electron-emitter display (SED) panel, a plasma display panel (PDP), a cathode ray tube (CRT) panel, an electrophoretic display (EPD) panel, etc.

Referring to FIG. 2, the liquid crystal lens may include a lens area LA and a non-lens area NLA. The electrodes EL1, EL2, and EL3 are disposed on the lens area LA. The electrodes EL1, EL2, and EL3 are spaced apart from each other. The liquid crystal layer 300 may be operated by the electrodes EL1, EL2, and EL3, and thus, the lens area LA may function as a lens. The electrodes EL1, EL2, and EL3 may extend in a first direction D1.

A plurality of lines (not illustrated) spaced apart from each other may be formed in, e.g., the lens area LA. The lines may apply voltages to the electrodes EL1, EL2, and EL3. For example, the lines may extend in a second direction D2, which is substantially perpendicular to the first direction D1.

A pad part (not illustrated) may be formed on the non-lens area NLA, applying voltages to the electrodes EL1, EL2, and EL3. First edges of the lines (not illustrated) may extend to the pad part and the first edges may form line pad electrodes (not illustrated).

Different voltages from each other may be applied to the electrodes EL1, EL2, and EL3, respectively. The voltages applied to the electrodes may be in a range from about 0V to about 10V.

When a strong voltage is applied to an electrode, the liquid crystal molecules 310, which are positioned adjacent to the electrode, may be arranged so that their major axes are substantially perpendicular to the first substrate 100. However, when a weak or no voltage is applied to an electrode, an initial arrangement of the liquid crystal molecules 310, which are positioned adjacent to the electrode, may be maintained.

The liquid crystal molecules 310 positioned adjacent to the electrode, which receives a strong voltage, may be aligned substantially perpendicular to the first substrate 100. The liquid crystal molecules 310 positioned adjacent to the electrode, which receives a weak or no voltage, may be aligned substantially parallel with the first substrate 100.

The electrodes EL1, EL2, and EL3 may be shaped like stripes. The electrodes EL1, EL2, and EL3 each may include a transparent conductor, such as indium tin oxide (ITO), indium zinc oxide (IZO), zinc oxide having a doped aluminum (AZO). For example, the electrodes EL1, EL2, and EL3 each may have a slit pattern.

A sealant 350 may be disposed in the non-lens area NLA, sealing the liquid crystal layer 300. The sealant 350 may be disposed on two opposite ends of the first substrate 100 and the second substrate 200.

The liquid crystal lens may include a first alignment layer 120 disposed on an upper surface of the first substrate 100. The liquid crystal lens may include a second alignment layer 210 disposed on a lower surface of the second substrate 200. The first and second alignment layers 120 and 210 may pre-tilt the molecules in the liquid crystal layer 300.

For example, the first alignment layer 120 and the second alignment layer 210 may be formed of an alignment material. For example, the alignment material may include polyimide (PI). The alignment material may be coated on the first substrate 100 and the second substrate 200, and may be then dried, forming the first alignment layer 120 and the second alignment layer 210.

The first alignment layer 120 and the second alignment layer 210 may be rubbed by using an aligning fabric or a roller.

For example, a rubbing direction of the first alignment layer 120 may be the first direction D1. A rubbing direction of the second alignment layer 210 may be a direction, which is tilted clockwise from the first direction D1 by about 5° to about 10°.

The alignment layers 120 and 210 may be omitted depending on the type of the liquid crystal layer or structures of the electrodes EL1, EL2, and EL3. For example, when the electrodes EL1, EL2, and EL3 have micro-slits that enable the liquid crystal to have an initial alignment, the first and second alignment layers 120 and 210 may be omitted. Furthermore, when the liquid crystal lens includes a mesogen layer for an initial alignment, the alignment layers 120, 210 may be omitted.

The liquid crystal lens may include a first polarizing plate 400 and a second polarizing plate 500. The first polarizing plate 400 may be disposed on a lower surface of the first substrate 100. The second polarizing plate 500 may be disposed on an upper surface of the second substrate 200.

For example, a polarization axis of the first polarizing plate 400 may be substantially perpendicular to the rubbing direction of the first alignment layer 120. A polarization axis of the second polarizing plate 500 may be tilted clockwise from the rubbing direction of the second alignment layer 210 by about 80° to about 90°. Therefore, the liquid crystal lens may operate in an electrically controlled birefringence mode (ECB).

The liquid crystal layer 300 may be formed between the first substrate 100 and the second substrate 200. The liquid crystal layer 300 may include liquid crystal molecules 310 and mesogens 320.

An alignment of the liquid crystal molecules 310 may be controlled by an electric field, which is formed by voltages applied to the electrodes EL1, EL2, and EL3. Thus, the liquid crystal molecules 310 may be aligned to form a desired configuration. For example, different voltages from each other are applied to the electrodes EL1, EL2, and EL3, respectively, thus allowing the liquid crystal layer 300 to function as a lenticular lens having a semicylinder-shaped convex portion.

When no voltages are applied to the electrodes EL1, EL2, and EL3, a major axis of the liquid crystal molecules 310 is aligned substantially parallel with the first and second substrates 100 and 200. The liquid crystal molecules 310 may be pre-tilted.

For example, the liquid crystal molecules 310 may be aligned in the rubbing direction of the first alignment layer 120. The liquid crystal molecules 310 may be aligned in the first direction D1.

The liquid crystal molecules 310 adjacent to the second substrate 200 may be aligned corresponding to the rubbing direction of the second alignment layer 210. The liquid crystal molecules 310 may be pre-tilted clockwise from the first direction D1 by about 10° or less. For example, the liquid crystal molecules 310 adjacent to the second substrate 200 may have a pre-tilted angle, which is equal to or less than about 10°.

When the liquid crystal molecules 310 are positioned in the middle portion of the first substrate 100 and the second substrate 200, the major axis of the liquid crystal molecules 310 may be parallel with an upper surface of the first substrate 100. The major axis of the liquid crystal molecules 310 may be aligned in the first direction D1.

The mesogens 320 may decrease a flow of the liquid crystal molecules 310 adjacent to the first substrate 100 and the second substrate 200.

The mesogens 320 may be disposed adjacent to the first substrate 100 and the second substrate 200. The mesogens 320 may be disposed between the liquid crystal molecules 310, which are adjacent to the first substrate 100 and the second substrate 200.

The mesogens 320 may be photo-cured. The mesogens 320 may be injected in a monomer state into the first substrate 100 and the second substrate 200. After the injection, voltages may be applied to the electrodes EL1, EL2, and EL3 and light, such as, e.g., ultraviolet (UV) rays, may be radiated to the mesogens 320. Accordingly, the mesogen monomers may react with each other. Thus, the mesogens 320 may be rendered to be adjacent to the first substrate 100 and the second substrate 200.

The mesogens 320 may assist in aligning the liquid crystal molecules 310. The mesogens 320 may have a similar structure to the liquid crystal molecules 310.

The mesogens 320 each have an aliphatic ring or an aromatic ring. The mesogens 320 each have a functional group at its terminal. The functional group may include a photoreactor. For example, the photoreactor may include an acrylate, a methacrylate, etc.

When light such as an ultraviolet ray is radiated to the mesogens 320, a plurality of the mesogens 320 reacts with an initiator, forming an oligomer, polymer or a mixture thereof.

Therefore, the mesogens 320 may be adjacent to the first substrate 100 and the second substrate 200, and the mesogens 320 may prevent a flow of the liquid crystal molecules 310. The mesogens 320 may prevent the liquid crystal molecules 310 from rotating to the rubbing directions of the first alignment layer 120 and the second alignment layer 210.

The weight of the mesogens 320 may be in a range from about 0.1% by weight to about 1.0% by weight, without the total weight of the liquid crystal composition.

When the amount of the mesogens 320 is equal to or less than about 0.1% by weight, with respect to the total weight of the liquid crystal composition, a high refraction liquid crystal may be difficult to control. When the amount of the mesogens 320 is greater than about 1.0% by weight, with respect to the total weight of the liquid crystal composition, the returning speed of a liquid crystal may be decreased, and thus, the response time of the liquid crystal display may be reduced.

FIG. 4 illustrates a phase shift of a liquid crystal as illustrated in FIG. 3 in accordance with an exemplary embodiment of the present invention.

For example, a first voltage V1, which is a relatively smallest voltage, may be applied to a first electrode EL1. A second voltage V2, which is higher than the first voltage V1, may be applied to a second electrode EL2. A third voltage V3, which is higher than the second voltage V2, may be applied to a third electrode EL3. The third voltage V3, which is a relatively highest voltage, may be applied to a third electrode EL3. The first voltage V1 may be applied to the first electrode EL1, which corresponds to a convex portion of the lens.

The major axis of the liquid crystal molecules 310 adjacent to the electrode (e.g., third electrode EL3), to which the highest voltage (e.g., third voltage V3) is applied, may be aligned to be substantially perpendicular to the first substrate 100. The major axis of the liquid crystal molecules 310 adjacent to the electrode (e.g., first electrode EL1), to which the smallest voltage (e.g., first voltage V1) is applied, may be aligned to be substantially parallel to the first substrate 100.

The liquid crystal molecules 310 may be aligned according to electric fields generated by the voltages V1, V2, and V3 applied to the electrodes EL1, EL2, and EL3, respectively. Therefore, the liquid crystal molecules 310 may be aligned to have a lens shape. For example, different voltages from each other are applied to the electrodes EL1, EL2, and EL3, respectively, and thus, the liquid crystal layer 300 may function as a lenticular lens having a semicylinder-shaped convex portion.

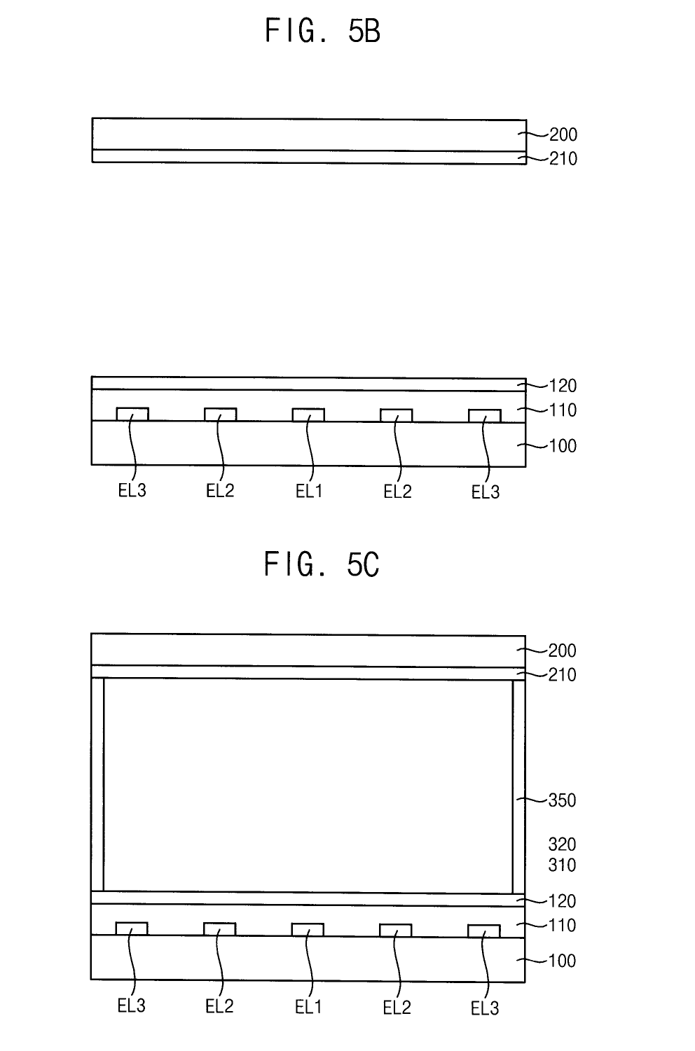

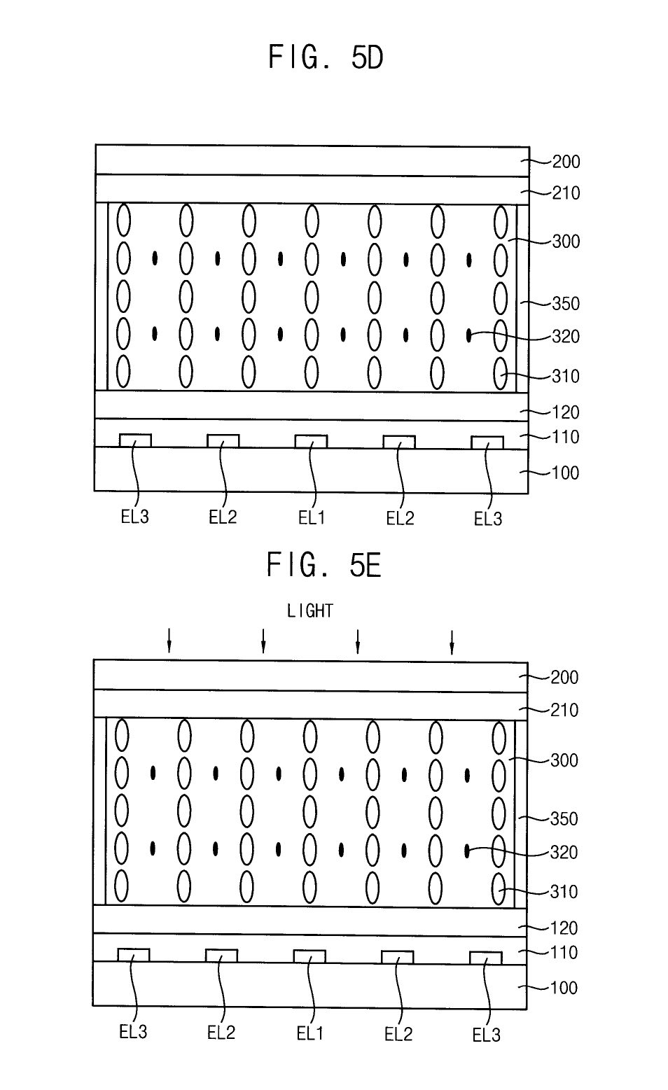

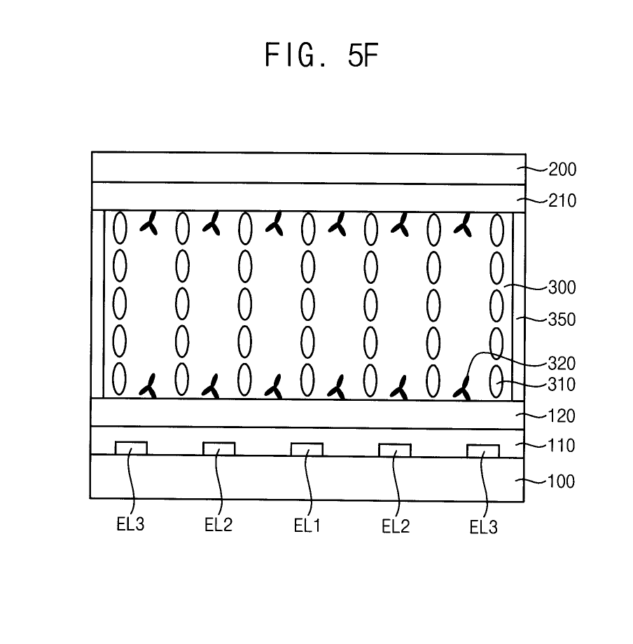

FIGS. 5A to 5F are cross-sectional views illustrating a method for manufacturing a liquid crystal lens in accordance with an exemplary embodiment of the present invention.

Referring to FIG. 5A, a first substrate 100 and a second substrate 200 facing the first substrate 100 are prepared. A plurality of electrodes EL1, EL2, and EL3 is formed on the first substrate 100.

The electrodes EL1, EL2, and EL3 may extend in a first direction D1. The electrodes EL1, EL2, and EL3 may be shaped like stripes. The electrodes EL1, EL2, and EL3 may include a transparent conductor, such as indium tin oxide (ITO), indium zinc oxide (IZO), or zinc oxide having a doped aluminum (AZO). For example, the electrodes EL1, EL2, and EL3 each may have a slit pattern.

An insulation layer 110 may be formed on the first substrate 100 and the electrodes EL1, EL2, and EL3.

The insulation layer 110 may be formed of an organic material or an inorganic material. Examples of the organic material and the inorganic material include a benzocyclobutene resin, an olefic resin, a polyimide resin, an acryl resin, a polyvinyl resin, a siloxane resin, a silicon resin, etc.

Referring to FIG. 5B, a first alignment layer 120 and a second alignment layer 210 may be formed on the first substrate 100 and the second substrate 200, pre-tilting liquid crystal molecules in the liquid crystal layer 300.

For example, the first alignment layer 120 and the second alignment layer 210 may be formed of an alignment material. The alignment material may be coated on the first substrate 100 and the second substrate 200, and may be then dried, forming the first alignment layer 120 and the second alignment layer 210.

The first alignment layer 120 and the second alignment layer 210 may be rubbed by using an aligning fabric or a roller.

For example, a rubbing direction of the first alignment layer 120 may be the first direction D1. A rubbing direction of the second alignment layer 210 may be a direction, which is tilted clockwise from the first direction D1 by about 5° to about 10°.

Referring to FIGS. 2 and 5C, a sealant 350 may be formed, sealing a liquid crystal layer 300.

A sealant 350 may be disposed on two opposite ends of the first substrate 100 and the second substrate 200.

The liquid crystal lens may include a lens area LA and a non-lens area NLA. A sealant 350 may be disposed on the non-lens area NLA, sealing the liquid crystal layer 300.

Referring to 5D, a liquid crystal composition may be injected between the first substrate 100 and the second substrate 200, forming the liquid crystal layer 300.

The liquid crystal composition may include liquid crystal molecules 310 and mesogens 320. The mesogens 320 may decrease a flow of the liquid crystal molecules.

When no voltages are applied to the electrodes EL1, EL2, and EL3, the major axis of the liquid crystal molecules 310 is aligned substantially parallel with the first the second substrates 100 and 200. The liquid crystal molecules 310 may be pre-tilted.

For example, the liquid crystal molecules 310 may be aligned in the rubbing direction of the first alignment layer 120. The liquid crystal molecules 310 may be aligned in the first direction D1.

The liquid crystal molecules 310 adjacent to the second substrate 200 may be aligned in the rubbing direction of the second alignment layer 210. The liquid crystal molecules 310 may be pre-tilted clockwise from the first direction D1 by about 10° or less. For example, the liquid crystal molecules 310 adjacent to the second substrate 200 may have a pre-tilted angle, which is equal to or less than about 10°.

When the liquid crystal molecules 310 are positioned in the middle portion of the first substrate 100 and the second substrate 200, the major axis of the liquid crystal molecules 310 may be aligned substantially parallel with an upper surface of the first substrate 100. The major axis of the liquid crystal molecules 310 may be aligned in the first direction D1.

Referring to FIGS. 5E and 5F, voltages may be applied to the electrodes EL1, EL2, and EL3, respectively, and light may be radiated to the liquid crystal layer 300 including the mesogens 320.

The mesogens 320 may be photo-cured. The mesogens 320 may be injected in a monomer state into the first substrate 100 and the second substrate 200. After the injection, voltages may be applied to the electrodes EL1, EL2, and EL3, respectively, and light may be radiated to the mesogens 320. The light may be an ultraviolet (UV) ray. When the light is radiated to the mesogens 320, the mesogen monomers of the mesogens 320 may react with each other. The light radiation may last during about 10 seconds to about 30 seconds.

Thus, the mesogens 320 may be rendered to be adjacent to the first substrate 100 and the second substrate 200. The mesogens 320 may be formed between the liquid crystal molecules 310 adjacent to the first substrate 100 and the second substrate 200.

Therefore, the mesogens 320 may be adjacent to the first substrate 100 and the second substrate 200, and the mesogens 320 may prevent a flow of the liquid crystal molecules 310. The mesogens 320 may prevent the liquid crystal molecules 310 from rotating to the rubbing directions of the first alignment layer 120 and the second alignment layer 210.

The weight of the mesogens 320 may be in a range from about 0.1% by weight to about 1.0% by weight, with respect to the total weight of the liquid crystal composition.

The liquid crystal lens may be formed by a liquid crystal composition including mesogens 320. Therefore, the anchoring energy and response speed of liquid crystal may be increased.

A liquid crystal lens and a liquid crystal display apparatus in accordance with exemplary embodiments of the present invention may be applicable to electronic devices, such as televisions, personnel computers, mobile devices, etc.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A liquid crystal lens, comprising:
a first substrate including a plurality of electrodes;
a second substrate facing the first substrate;
a liquid crystal layer disposed between the first substrate and the second substrate, the liquid crystal layer including liquid crystal molecules and a mesogen, wherein the mesogen includes an acrylate functional group; and
an alignment layer disposed between the liquid crystal layer and the first substrate, or between the liquid crystal layer and the second substrate.

2. The liquid crystal lens of claim 1, wherein the alignment layer comprises a first alignment layer disposed between the liquid crystal layer and the first substrate and a second alignment layer disposed between the liquid crystal layer and the second substrate.

3. The liquid crystal lens of claim 1, wherein the alignment layer comprises polyimide.

4. The liquid crystal lens of claim 1, further comprising an insulation layer disposed on the plurality of electrodes.

5. The liquid crystal lens of claim 1, wherein different voltages from each other are applied to the plurality of electrodes, respectively.

6. The liquid crystal lens of claim 5, wherein the voltages are in a range from about 0V to about 10V.

7. The liquid crystal lens of claim 1, wherein the plurality of electrodes each have a stripe shape.

8. The liquid crystal lens of claim 1, wherein a pre-tilted angle of the liquid crystal molecules adjacent to the mesogen is equal to or less than 10°.

9. The liquid crystal lens of claim 1, further comprising:
a first polarizing plate disposed on a lower surface of the first substrate; and
a second polarizing plate disposed on an upper surface of the second substrate.

10. The liquid crystal lens of claim 1, further comprising a sealant disposed on each of two opposite ends of the first substrate and the second substrate.

11. A liquid crystal display apparatus, comprising:
a liquid crystal lens including:
a first substrate including a plurality of electrodes;
a second substrate facing the first substrate;
a liquid crystal layer disposed between the first substrate and the second substrate, the liquid crystal layer including liquid crystal molecules and a mesogen, wherein the mesogen includes an acrylate functional group contacting the liquid crystal layer; and
an alignment layer disposed between the liquid crystal layer and the first substrate or between the liquid crystal layer and the second substrate; and
a display panel disposed on a lower surface of the liquid crystal lens.

12. The display apparatus of claim 11, wherein the alignment layer comprises a first alignment layer disposed between the liquid crystal layer and the first substrate, and a second alignment layer disposed between the liquid crystal layer and the second substrate.

13. The display apparatus of claim 11, wherein the alignment layer comprises polyimide.

14. The display apparatus of claim 11, further comprising:
an insulation layer disposed on the plurality of electrodes.

15. The display apparatus of claim 11, wherein different voltages from each other are applied to the plurality of electrodes, respectively.

16. The display apparatus of claim 15, wherein the voltages are in a range from about 0V to about 10V.

17. The display apparatus of claim 11, wherein the plurality of electrodes each have a stripe shape.

18. The display apparatus of claim 11, wherein a pre-tilted angle of the liquid crystal molecules adjacent to the mesogen is equal to or less than 10°.

19. The display apparatus of claim 11, further comprising:
a first polarizing plate disposed on a lower surface of the first substrate; and
a second polarizing plate disposed on an upper surface of the second substrate.

20. The display apparatus of claim 11, further comprising a sealant disposed on each of two opposite ends of the first substrate and the second substrate.
